(19) United States
(12) Patent Application Publication
(10) Pub. No.: US 2026/0184359 A1
(43) Pub. Date: Jul. 2, 2026

(54) TOWABLE WHEELED BAG

(71) Applicant: Dongguan Yaoyu Plastic Hardware Products Co., Ltd., DONGGUAN (CN)

(72) Inventor: ZUJIE ZHANG, Dongguan City (CN)

(21) Appl. No.: 19/004,225

(22) Filed: Dec. 28, 2024

(51) Int. Cl. B62B 3/02; A63B 55/60; B62B 3/10

(52) U.S. Cl. CPC B62B 3/025; A63B 55/60; B62B 3/106; B62B 2202/407

(57) ABSTRACT

The present invention discloses a towable wheeled bag. The wheeled bag includes: a ball bag provided with a roller at a bottom portion thereof and a hinge seat at a ball bag back portion; and a universal wheel bracket hinged on the hinge seat, the hinge seat is provided with a socket, the universal wheel bracket is provided with a latch guide groove, a latch is movably engaged in the latch guide groove, the latch is provided with a notch at a middle portion thereof, a return spring is provided between a tail portion of the latch and an inner wall of the latch guide groove, a head portion of the latch is configured to be inserted into the socket, and a paddle switch is provided in the notch.

### BACKGROUND OF THE INVENTION

### Field of the Invention

The present invention relates to the field of leisure sports goods, and in particular to a golf bag.

### Description of Related Art

A golf cart is a tool used to carry golf bags. When playing a ball game on a golf course, in order to avoid carrying the golf bag and reduce a load, the golf cart is generally used, and the golf bag is placed on the golf cart, so that a hitter can pull the golf cart by hand. However, before use, the golf bag and the cart need to be assembled together, and after use, the golf bag and the cart need to be disassembled. When the golf bag and the cart are carried by a car, the golf bag and the cart need also to be carried separately, which is troublesome to use and takes up space when storing the golf bag and the cart.

### SUMMARY OF THE INVENTION

The technical problem to be solved by the present invention is that the golf cart and the golf bag are designed separately, which is inconvenient to use and requires a large storage space.

In order to solve the above-described technical problem, technical solutions of the present invention are as follows. A towable wheeled bag includes: a ball bag provided with a roller at a bottom portion thereof and a hinge seat at a ball bag back portion; and a universal wheel bracket hinged on the hinge seat, the hinge seat is provided with a socket, the universal wheel bracket is provided with a latch guide groove, a latch is movably engaged in the latch guide groove, the latch is provided with a notch at a middle portion thereof, a return spring is provided between a tail portion of the latch and an inner wall of the latch guide groove, a head portion of the latch can be inserted into the socket, and a paddle switch is provided in the notch.

When playing a ball game, a user toggles the paddle switch to move the latch along the latch guide groove, the head portion of the latch is separated from the socket, the universal wheel bracket is unfolded, the universal wheel bracket forms a certain angle with the ball bag, a roller at the bottom portion of the ball bag and a universal wheel at a bottom portion of the universal wheel bracket touch the ground, and the universal wheel bracket supports the tilted ball bag. When the ball bag needs to be moved, the user pulls the ball bag, and the ball bag moves under the actions of the roller and the universal wheel. When leaving a course after the ball game, the user folds the universal wheel bracket to the ball bag back portion and inserts the head portion of the latch into the socket of the hinge seat, thereby locking the universal wheel bracket to the ball bag back portion.

In the towable wheeled bag according to the present invention, the universal wheel bracket is directly provided on the ball bag back portion, when in use, the universal wheel bracket is unfolded and the towable wheeled bag has the function of a golf cart; and when not in use, the universal wheel bracket is folded at the ball bag back portion and does not take up space.

The paddle switch is movably engaged in the notch, the paddle switch is provided with a paddle switch hinge shaft at a bottom end thereof, and the paddle switch hinge shaft is hinged on a bottom cover plate of the latch guide groove. The user toggles the paddle switch to rotate the paddle switch around the paddle switch hinge shaft, thereby driving the latch to linearly move along the latch guide groove. According to the present invention, the paddle switch and the latch are movably engaged, which facilitates the linear movement of the latch along the latch guide groove smoothly and prevents the latch from getting stuck during the movement process.

As an improvement, the paddle switch is hollow, and the paddle switch can undergo elastic deformation when being subjected to a reaction force of the latch, thereby preventing the paddle switch from getting stuck during the toggling process and preventing the paddle switch from breaking after long-term use.

The socket includes a bracket folding socket and a bracket unfolding socket, and when the head portion of the latch engages with the bracket folding socket, the universal wheel bracket is close to the ball bag back portion, and when the head portion of the latch engages with the bracket unfolding socket, the universal wheel bracket is away from the ball bag back portion. The head portion of the latch engages with the bracket folding socket, and the head portion of the latch engages with the bracket unfolding socket, both of which play a role in locking the universal wheel bracket.

The universal wheel bracket includes a bracket head portion and a support rod connected to the bracket head portion, a universal wheel is mounted on a bottom end of the support rod, the latch guide groove is provided on the bracket head portion, and the bracket head portion is provided with a hinge lug hinged with the hinge seat.

A torsion spring is provided on a hinge shaft between the universal wheel bracket and the hinge seat. Any one end of the torsion spring is pressed into a U-shaped bayonet on the hinge seat, and the other end is pressed into a U-shaped bayonet of the hinge lug. The torsion spring makes the universal wheel bracket have a tendency to move away from the ball bag back portion, so that under the action of the torsion spring, the universal wheel bracket can be automatically unfolded.

The ball bag back portion is provided with a contoured recessed structure that is contoured to the universal wheel bracket, the contoured recessed structure can accommodate the universal wheel bracket, and the hinge seat is located in the contoured recessed structure. By the design of the contoured recessed structure, after the universal wheel bracket is accommodated, the ball bag back portion is flat, which is convenient for the user to carry the ball bag.

The towable wheeled bag according to the present invention has the functions of both a ball bag and a cart, is easy to use, and is easy to accommodate.

### BRIEF DESCRIPTION OF THE DRAWINGS

The present invention will be further described below with reference to the accompanying drawings.

FIG. 1 is a schematic diagram of a towable wheeled bag, which is in an accommodated state.

FIG. 2 is a schematic diagram of the towable wheeled bag, which is in an unfolded state.

FIG. 3 is a front view of a ball bag back portion 20.

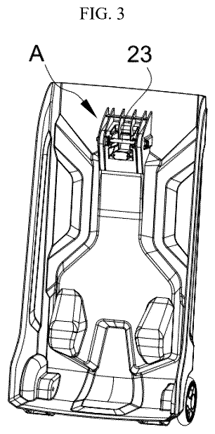

FIG. 4 is an enlarged view of part A in FIG. 3.

FIG. 5 is a back view of the ball bag back portion 20.

FIG. 6 is an enlarged view of part B in FIG. 5.

FIG. 7 is a schematic diagram of a universal wheel bracket 10.

FIG. 8 is an exploded view of FIG. 7.

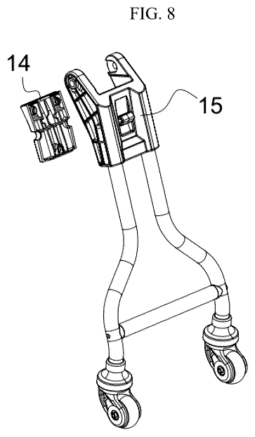

FIG. 9 is a partially enlarged view of part B in FIG. 8.

FIG. 10 is a schematic diagram of the universal wheel bracket 10 from another viewing angle.

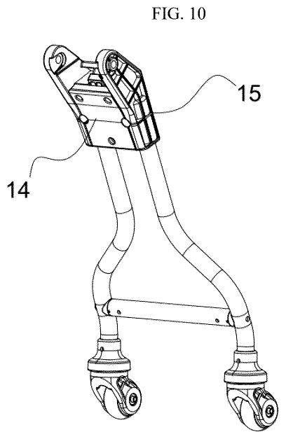

FIG. 11 is an exploded view of FIG. 10.

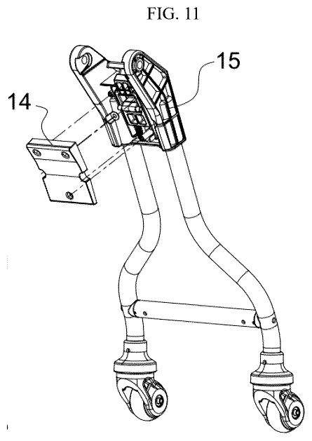

FIG. 12 is a partially enlarged view of part B in FIG. 11.

### REFERENCE SIGNS LIST

10: universal wheel bracket; 11: latch; 110: notch; 12: return spring; 13: paddle switch; 130: paddle switch hinge shaft; 14: bottom cover plate; 140: paddle switch hinge shaft; 15: bracket head portion; 150: hinge lug; 151: U-shaped bayonet of hinge lug; 16:
support rod; 17: universal wheel; 20: ball bag back portion; 21: roller; 22: hinge seat; 221:
   bracket folding socket; 222: bracket unfolding socket; 223: U-shaped bayonet on hinge seat;
23: hinge shaft; 24: torsion spring; 25: contoured recessed structure.

### DETAILED DESCRIPTION OF THE INVENTION

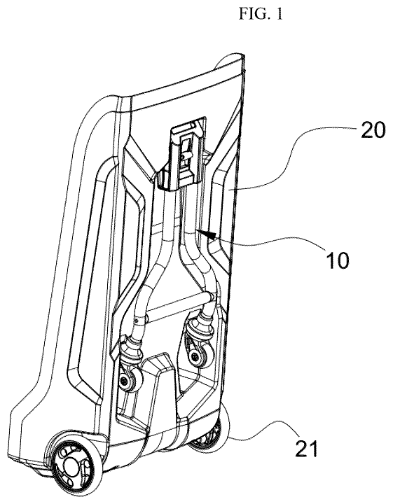

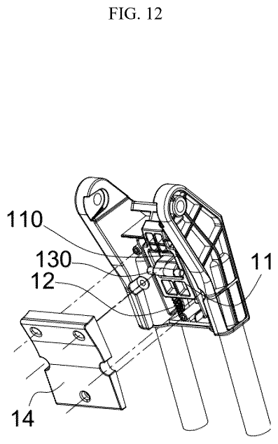

As shown in FIGS. 1, 2, 9, and 12, a towable wheeled bag includes: a ball bag provided with rollers 21 at a bottom portion thereof and a hinge seat 22 at a ball bag back portion 20; and a universal wheel bracket 10 hinged on the hinge seat, the hinge seat is provided with a socket, the universal wheel bracket is provided with a latch guide groove, a latch 11 is movably engaged in the latch guide groove, the latch is provided with a notch 110 at a middle portion thereof, a return spring 12 is provided between a tail portion of the latch and an inner wall of the latch guide groove, a head portion of the latch is configured to be inserted into the socket, and a paddle switch 13 is provided in the notch.

The paddle switch 13 is movably engaged in the notch 110, the paddle switch is provided with a paddle switch hinge shaft 130 at a bottom end thereof, and the paddle switch hinge shaft is hinged on a bottom cover plate 14 of the latch guide groove.

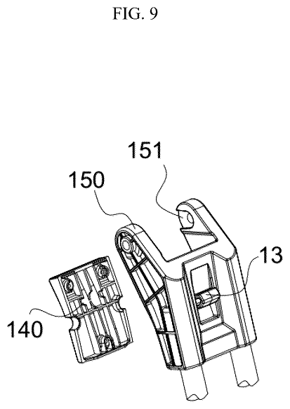

As shown in FIG. 9, the paddle switch 13 is hollow. The paddle switch can undergo elastic deformation when being subjected to a reaction force of the notch 110 of the latch, thereby preventing the paddle switch 13 from getting stuck during the toggling process and preventing the paddle switch from breaking after long-term use.

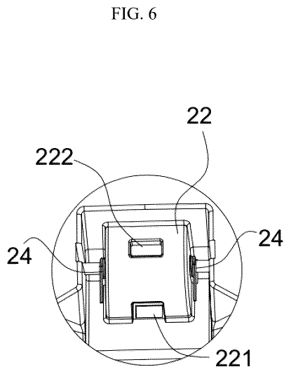

As shown in FIG. 6, the socket includes a bracket folding socket 221 and a bracket unfolding socket 222, and when the head portion of the latch 11 engages with the bracket folding socket, the universal wheel bracket 10 is close to the ball bag back portion 20, and when the head portion of the latch engages with the bracket unfolding socket, the universal wheel bracket is away from the ball bag back portion.

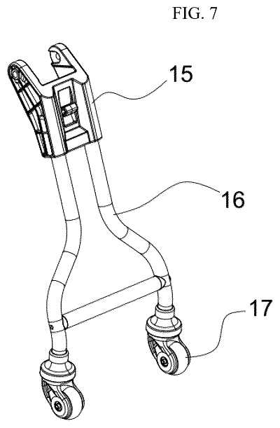

As shown in FIG. 7, the universal wheel bracket 10 includes a bracket head portion 15 and a support rod 16 connected to the bracket head portion, universal wheels 17 are mounted on bottom ends of the support rod, the latch guide groove is provided on the bracket head portion, and the bracket head portion is provided with hinge lugs 150 hinged with the hinge seat.

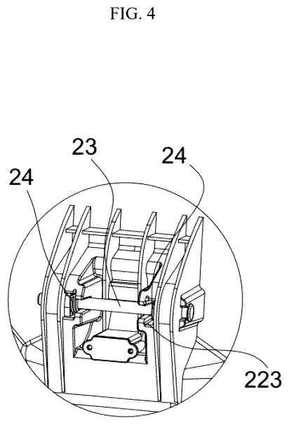

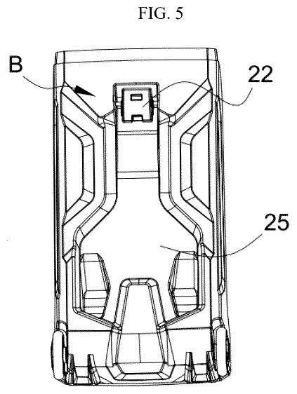

As shown in FIGS. 4 and 5, a torsion spring 24 is provided on a hinge shaft 23 between the universal wheel bracket 10 and the hinge seat. Any one end of the torsion spring is pressed into a U-shaped bayonet 223 on the hinge seat, and the other end is pressed into a U-shaped bayonet 151 of the hinge lug. The torsion spring 24 makes the universal wheel bracket 10 have a tendency to move away from the ball bag back portion 20, so that under the action of the torsion spring, the universal wheel bracket 10 can be automatically unfolded.

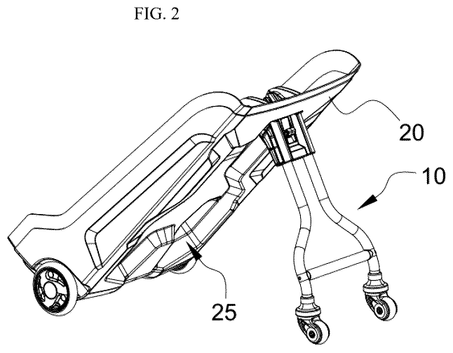

As shown in FIG. 2, the ball bag back portion 20 is provided with a contoured recessed structure 25 that is contoured to the universal wheel bracket, the contoured recessed structure can accommodate the universal wheel bracket 10, and the hinge seat 22 is located in the contoured recessed structure.

When playing a ball game, a user toggles the paddle switch 13 to rotate the paddle switch around the paddle switch hinge shaft 130, thereby driving the latch 11 to linearly move along the latch guide groove, the head portion of the latch is separated from the bracket folding socket 221, under the elastic force of the torsion spring 24, the universal wheel bracket 10 is automatically unfolded, and the universal wheel bracket forms a certain angle with the ball bag. At this time, the head portion of the latch 11 is aligned with the bracket unfolding socket 222, and under the action of the return spring 12, the head portion of the latch 11 is inserted into the bracket unfolding socket 222, and the deployment state of the universal wheel bracket 10 is locked. As shown in FIG. 2, rollers 21 at the bottom portion of the ball bag and the universal wheels 17 at a bottom portion of the universal wheel bracket 10 touch the ground, and the universal wheel bracket supports the tilted ball bag. When the ball bag needs to be moved, the user pulls the ball bag, and the ball bag moves under the actions of the rollers 21 and the universal wheels 17.

When leaving a course after the ball game, the user toggles the paddle switch 13 to rotate the paddle switch around the paddle switch hinge shaft 130, thereby driving the latch 11 to linearly move along the latch guide groove, the head portion of the latch is separated from the bracket unfolding socket 222. The user folds the universal wheel bracket 10 to the ball bag back portion 20 and inserts the head portion of the latch 11 into the bracket folding socket 221, thereby locking the universal wheel bracket 10 to the ball bag back portion 20, as shown in FIG. 1.

The above-described content is merely a preferred embodiment of the present invention, and for those skilled in the art, according to the concept of the present invention, changes may be made in the specific embodiments and application ranges, and the content of the present specification should not be understood as a limitation on the present invention.

The present invention discloses a towable wheeled bag. The wheeled bag includes: a ball bag provided with a roller at a bottom portion thereof and a hinge seat at a ball bag back portion; and a universal wheel bracket hinged on the hinge seat, the hinge seat is provided with a socket, the universal wheel bracket is provided with a latch guide groove, a latch is movably engaged in the latch guide groove, the latch is provided with a notch at a middle portion thereof, a return spring is provided between a tail portion of the latch and an inner wall of the latch guide groove, a head portion of the latch is configured to be inserted into the socket, and a paddle switch is provided in the notch. When playing a ball game, the latch is disengaged from the socket, the universal wheel bracket is unfolded, the universal wheel bracket supports the tilted ball bag, and a user can move the ball bag conveniently. When leaving a course after the ball game, the universal wheel bracket is folded at the ball bag back portion. In this design of the towable wheeled bag, the universal wheel bracket is directly provided on the ball bag back portion, when in use, the universal wheel bracket is unfolded and the towable wheeled bag has the function of a golf cart; and when not in use, the universal wheel bracket is folded at the ball bag back portion and does not take up space.

What is claimed is:

1. A towable wheeled bag comprising: a ball bag provided with a roller (21) at a bottom portion thereof and a hinge seat (22) at a ball bag back portion (20); and a universal wheel bracket (10) hinged on the hinge seat, wherein the hinge seat is provided with a socket, the universal wheel bracket is provided with a latch guide groove, a latch (11) is movably engaged in the latch guide groove, the latch is provided with a notch (110) at a middle portion thereof, a return spring (12) is provided between a tail portion of the latch and an inner wall of the latch guide groove, a head portion of the latch is configured to be inserted into the socket, and a paddle switch (13) is provided in the notch.

2. The towable wheeled bag according to claim 1, wherein the paddle switch (13) is movably engaged in the notch (110), the paddle switch is provided with a paddle switch hinge shaft (130) at a bottom end thereof, and the paddle switch hinge shaft is hinged on a bottom cover plate (14) of the latch guide groove.

3. The towable wheeled bag according to claim 2, wherein the paddle switch (13) is hollow.

4. The towable wheeled bag according to claim 1, wherein the socket includes a bracket folding socket (221) and a bracket unfolding socket (222), and when the head portion of the latch (11) engages with the bracket folding socket, the universal wheel bracket (10) is close to the ball bag back portion (20), and when the head portion of the latch engages with the bracket unfolding socket, the universal wheel bracket is away from the ball bag back portion.

5. The towable wheeled bag according to claim 1, wherein the universal wheel bracket (10) includes a bracket head portion (15) and a support rod (16) connected to the bracket head portion, a universal wheel (17) is mounted on a bottom end of the support rod, the latch guide groove is provided on the bracket head portion, and the bracket head portion is provided with a hinge lug (150) hinged with the hinge seat.

6. The towable wheeled bag according to claim 1, wherein a torsion spring (24) is provided on a hinge shaft (23) between the universal wheel bracket (10) and the hinge seat.

7. The towable wheeled bag according to claim 1, wherein the ball bag back portion (20) is provided with a contoured recessed structure (25) that is contoured to the universal wheel bracket, the contoured recessed structure is configured to accommodate the universal wheel bracket (10), and the hinge seat (22) is located in the contoured recessed structure.
